(19) United States
(12) Patent Application Publication
(10) Pub. No.: US 2022/0334883 A1
(43) Pub. Date: Oct. 20, 2022

(54) DEPLOYING MULTI-ENTERPRISE APPLICATIONS IN A SHARED COMPUTING ENVIRONMENT

(71) Applicant: TRACELINK, INC., North Reading, MA (US)

(72) Inventors: Chris DRISCOLL, Methuen, MA (US); Robert STURIM, Wenham, MA (US); Shabbir DAHOD, Andover, MA (US)

(21) Appl. No.: 17/233,112

(22) Filed: Apr. 16, 2021

(51) Int. Cl. G06F 9/50; G06F 9/54; G06F 9/455; G06F 21/12

(52) U.S. Cl. CPC G06F 9/5072; G06F 9/542; G06F 9/45516; G06F 21/121

(57) ABSTRACT

The deployment of a multi-enterprise application in a shared computing environment includes the generation of multiple different instances of a context management object from a genetically incorporated segment of a single collection of program code, the code having been arranged to restrict access to one or both of application features and application data according to a tokenized relationship between a requesting entity issuing a request to a corresponding application, and an owner of the corresponding application. Thereafter, requests targeting the corresponding application are processed through the creation of an instance of the context management object according to a token supplied with each request and the specification of the requesting entity and the corresponding application. The genetically incorporated segment then moderates the access to the application features and the application data irrespective of the corresponding application.

### BACKGROUND OF THE INVENTION

### Field of the Invention

The present invention relates to the technical field of enterprise computing and more particularly to the deployment of an enterprise application in a multi-user computing environment.

### Description of the Related Art

Traditional computing includes the execution of a computer program in memory of a computer by a processor of the computer. Ordinarily, a single user accesses a corresponding single computer program at any one time; however, some multi-user computer programs permit the simultaneous access of the computer program and the data produced and accessible therein. Within a single organization, supporting a multi-user computer program makes sense. In this regard, within a single organization, data sharing is permitted and thus, each individual accessing the multi-user computer program may be permitted to access the same data. As well, to the extent that different users within the same organization enjoy different access rights to different data, certain portions of the data can be restricted from access for different users.

The computing resources required to support the execution of a single application generally are limited and therefore manageable. Even for a small organization, maintaining a minimal closet of computing resources is only a small burden. But, to support the execution of multiple computer programs so as to accommodate a large number of simultaneous users within an organization, a large number of computing resources are required. As such, many organizations elect to outsource the hosting of physical computing resources to a remote, managed site. As well, to the extent that different users within an organization may be geographically dispersed, hosting multiple computing resources in a centrally disposed location or even at multiple different locations can be of great importance.

Notwithstanding, despite the efficiencies gained by remotely positioning one's own multi-user computer programs in a hosted server farm, managed, hosted services can be quite costly—especially in terms of software licensing fees and also owing to the fact that typically, each application hosted for a particular organization is placed in its own container of execution so that the execution of an application instance in one container cannot influence or interact with an executing application instance for a different organization. Consequently, modern trends in computing capitalize on the notion of a multi-tenant computing environment. A multi-tenant computing environment is a hosted computing environment in which a single instance of a computer program executes in a centralized computing infrastructure while remaining accessible to multiple different users across multiple different organizations. In particular, in comparison to a multi-instance architecture, in a multi-tenant environment, each tenant is a group of users sharing common access with specific privileges to a single instance of the computer program. Each tenant then enjoys a dedicated share of the single instance of the computer program, including corresponding data, configuration, user management, tenant individual functionality and non-functional properties.

It is a distinct advantage of the multi-tenancy architecture that all subscribers, also known as “tenants”, receive access to a most recent version of a commonly accessed application since updating the application for one tenant necessarily means updating the application for all tenants. However, it is a less obvious, but equally important disadvantage of a multi-tenant environment that all subscribers are compelled to use an identical version of an application since all subscribers access the same instance of the same application at any given time. But in many instances, it may be desirable to segregate different instances of an application according to different sets of participants to each application in which the different sets share information in a product, albeit exclusive way. Indeed, in many cases a single participant to an application may interact with other participants across multiple different sets of participants. Consequently, multiple different instances of the same application must be maintained for the different sets of participants with a given participant knowing a priori which application instance to select for participation at a given time, thereby defeating the efficiency of the multi-tenancy architecture.

### BRIEF SUMMARY OF THE INVENTION

Embodiments of the present invention address technical deficiencies of the art in respect to multi-tenancy computing. To that end, embodiments of the present invention provide for a novel and non-obvious method for deploying multi-enterprise applications in a shared computing environment. Embodiments of the present invention also provide for a novel and non-obvious computing device adapted to perform the foregoing method. Finally, embodiments of the present invention provide for a novel and non-obvious data processing system incorporating the foregoing device in order to perform the foregoing method.

In one embodiment of the invention, a method for deploying multi-enterprise applications in a shared computing environment includes assembling different sets of logical components into different applications for each of the sets. The method also includes rendering each of the different applications accessible through a common event bus within a single computing container managed by a single runtime process. The method further includes assigning to each of the applications, an owner and one or more partners, such that the owner is associated with a deployment and use of a corresponding one of the different applications, and that each of the partners is associated only with the use of the corresponding one of the different applications.

Notably, the runtime then generates multiple different instances of a context management object from a genetically incorporated segment of a single collection of program code that is arranged to restrict access to one or both of application features and application data according to a tokenized relationship between a requesting entity issuing a request to a corresponding one of the different applications, and an owner of the corresponding one of the different applications. Thereafter, the runtime processes requests from requesting entities, each of the requests targeting one of the different applications in order to access the application features and application data of the one of the different applications. In this regard, the runtime processes a request by creating an instance of the context management object according to a token supplied with the request which specifies the requesting entity and a target one of the applications. The genetically incorporated segment of the instance of the context management object then moderates the access to the application features and application data irrespective of a particular one of the different applications targeted by the request.

In one aspect of the embodiment, each request is received in an event gateway external to the runtime and each request is authenticated before a token is created at the event gateway so as to be provided with the request to the runtime. In another aspect of the embodiment, the created instance of the context management object invokes a method corresponding to the request. In yet a further aspect of the embodiment, the created instance of the context management object is provided to an event handler specified by the request.

In another embodiment of the invention, a data processing system is adapted for deploying multi-enterprise applications in a shared computing environment. The system includes a host computing platform having one or more computers, each with memory and one or processing units including one or more processing cores. The system also includes a common event bus defined in the memory and a single computing container executing in the container by the processing cores and hosting different sets of logical components in different applications rendered accessible through the common event bus. Notably, each of the applications has assigned thereto, an owner and one or more partners, the owner being associated with a deployment and use of a corresponding one of the different applications, and each of the partners being associated only with the use of the corresponding one of the different applications.

Importantly, the system includes a runtime. Specifically, the runtime includes computer program instructions enabled while executing in the memory of at least one of the processing units of the host computing platform to generate multiple different instances of a context management object from a genetically incorporated segment of a single collection of program code that is arranged to restrict access to one or both of application features and application data according to a tokenized relationship between a requesting entity issuing a request to a corresponding one of the different applications, and an owner of the corresponding one of the different applications. The computer program instructions also process requests from requesting entities.

More specifically, each of the requests targets a different one of the applications, and requests access to the application features and application data of the targeted application. The computer program instructions specifically process each request by creating one of the instances of the context management object according to a token supplied with each of the requests, the token specifying the requesting entity and a targeted one of the applications. The genetically incorporated segment in turn moderates the access to the application features and application data irrespective of a particular one of the different applications targeted by the request. In this way, the technical deficiencies of the multi-tenancy computing environment in supporting multiple different enterprises utilizing a common application are overcome owing to the ability to provide end-to-end seamless application data and functionality control based upon a context driven management of application requests within a single computing container without burdening the requestor with the knowledge of the underlying computing runtime processing the application requests.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of a process of deploying multi-enterprise applications in a shared computing environment;

FIG. 2 is a block diagram depicting a data processing system adapted to perform one of the aspects of the process of FIG. 1; and,

FIG. 3 is a flow chart illustrating one of the aspects of the process illustrated in FIG. 1.

### DETAILED DESCRIPTION OF THE INVENTION

Embodiments of the invention provide for deploying multi-enterprise applications in a shared computing environment. In accordance with an embodiment of the invention, within a single computing container in which multiple different instances of multiple different applications execute, a runtime is established managing requests issued to different ones of the different application instances, each of the instances implicating a different set of participants. In order to resolve access to data and operations of the different instances, a context management object is created by the runtime along with each of the instances, the context management object deriving from a genetically incorporated segment of a single collection of program code that is arranged to restrict access to one or both of application features and application data according to a tokenized relationship between a requesting entity issuing a request to a corresponding one of the different applications, and an owner of the corresponding one of the different applications. In this way, requests received on an event bus common to all of the applications instances are resolved by the program code of the context management object in respect to a specific one of the application instances without the necessity of the request specifying the specific data and operations of a corresponding one of the instances to which the request is directed.

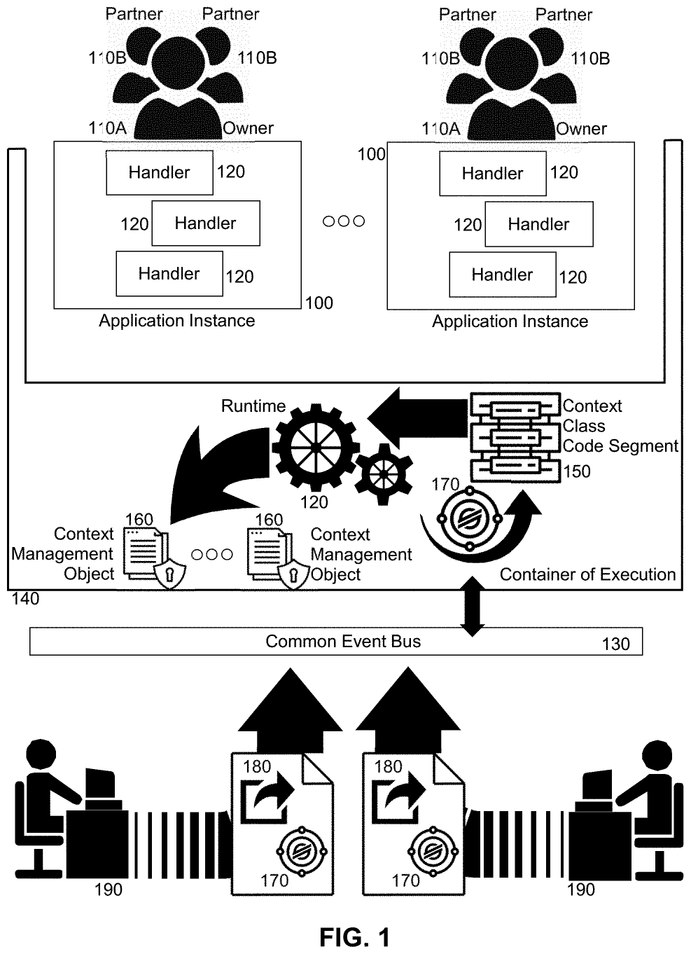

In illustration of one aspect of the embodiment, FIG. 1 pictorially shows a process of deploying multi-enterprise applications in a shared computing environment. As shown in FIG. 1, different logical event handlers 120 are combined in different arrangements for an application instance 100 executing within a single container of execution 140. Each application instance 100 has an owner 110A and one or more partners 110B. The owner 110A administers the corresponding application instance 100 and defines the partners 110B permitted to access the application instance 100. As well, the owner 110A in administering the application instance 100, defines which of the event handlers 120 each of the partners 110B may access, the event handlers processing specific events. To that end, each of the application instances 100 are coupled to a common event bus 130 on which events are received targeting specific ones of the application instances 100 and which are ultimately processed by one or more of the event handlers 120 of the targeted one of the application instances 100.

Importantly, within the container of execution 140, a runtime 120 for the container of execution 140 creates different context management objects 160 to manage the requests 180 received from different requestors 190 (inherently either an owner 110A or a partner 110B) for a specific one of the application instances 110 within the single container of execution 140) seeking access to targeted ones of the application instances 100 and to underlying functionality supplied by the components 120 of the application instances 100 and data accessible in a data layer by the components 120. More specifically, the runtime 120 creates each of the different context management objects 160 upon receiving a request 180 from a requestor 190.

The request 180 includes, therewith, a token 170 specifying both an identity of the requestor 190 and a targeted one of the application instances 100. The runtime 120 then creates a corresponding one of the context management objects 160 from templated code segment 150 defining the method and data members of the created one of the context management objects 160 using the information from the token 170 to particularize the templated code segment 150 into the created one of the context management objects 160. To that end, the templated code segment can be a class from which the context management objects 160 are instantiated with the identity of the requestor 190 and targeted one of the application instances 100 as constructor parameters.

Once created, each context management object 160 processes requests from corresponding ones of the requestors 190 to limit the functionality and data of a targeted one of the application instances 100 accessed by each one of the requestors 190. For instance, the context management object 160 can include within its own method membership, a discrete set of operations of the components 120 of a corresponding one of the application instances 100 accessible by a corresponding one of the requestors 190, thus inherently limiting access to the functionality and data of the corresponding one of the application instances 100 for the corresponding requestor 190 for which the context management object 160 had been created. As well, the context management object 160 can expose access to one or more event handlers of an application instance 100 to the extent that one or more of the components 120 of the application instance 100 are event handlers.

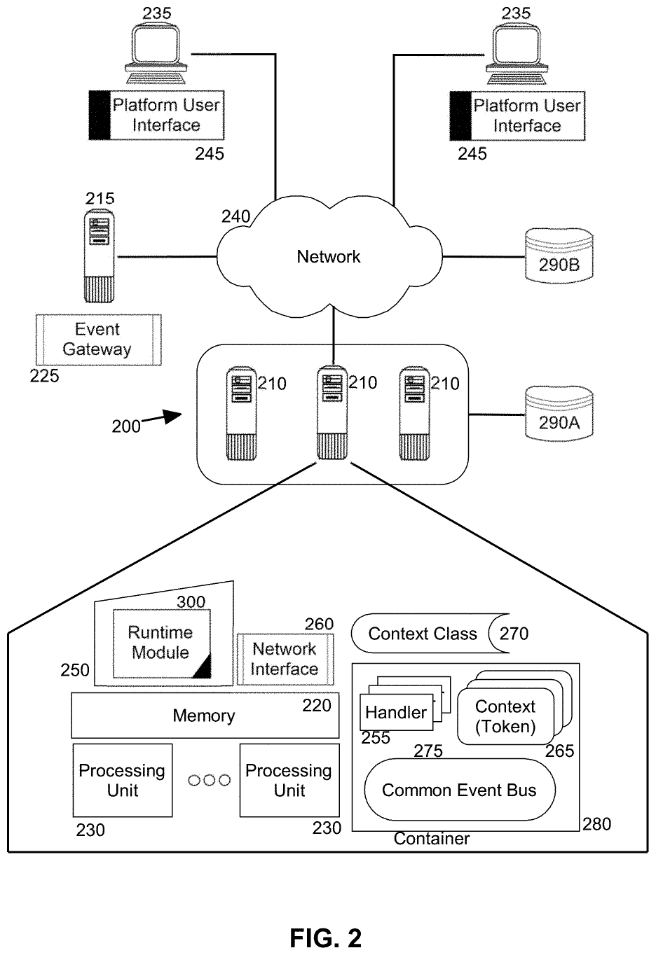

Aspects of the process described in connection with FIG. 1 can be implemented within a data processing system. In further illustration, FIG. 2 schematically shows a data processing system adapted to perform deploying multi-enterprise applications in a shared computing environment. In the data processing system illustrated in FIG. 1, a host computing platform 200 is provided. The host computing platform 200 includes one or more computers 210, each with memory 220 and one or more processing units 230. The computers 210 of the host computing platform can be co-located within one another and in communication with one another over a local area network, or over a data communications bus, or the computers can be remotely disposed from one another and in communication with one another through network interface 260 over a data communications network 240. As well, the computers 210 can be communicatively linked to fixed data storage 290A, 290B, either locally over a data communications bus, or remotely over the data communications network 240.

Notably, a computing device 250 including a non-transitory computer readable storage medium can be included with the data processing system 200 and accessed by the processing units 230 of one or more of the computers 210. The computing device stores 250 thereon or retains therein a program module 300 that includes computer program instructions which when executed by one or more of the processing units 230, performs a programmatically executable process for deploying multi-enterprise applications in a shared computing environment. Specifically, the program instructions during execution deploy multiple different application instances into a single container of execution 280 defined in the memory 220, for example a virtual machine or short-lived container.

Each of the application instances can be accessed from over computer communications network 240 by different computing clients 235 through respectively different user interfaces 245 so as to generate events processible on a common event bus 275, also defined within the memory 220, by a targeted one of the application instances. As such, the application instances include one or more different event handlers 255 processing events received on the common event bus 275. Optionally, the events are preprocessed in an event gateway 225 within a separate computing system 215 in which a requestor originating the event is first authenticated before the event is routed onto the common event bus 275.

The program instructions upon receiving an event on the common event bus 275, extract from the event, a token specifying an identity and permissions of the requestor and a targeted application instance. Using the token, the program instructions create a context management object 265 based upon genetically incorporated context management code 270 particularized according to the token. The program instructions then process the event 265 so as to restrict access to the data and functionality of the targeted application instance in the single container in the created context management object of execution 280 including invoking a particular one of the event handlers 255 implicated by the request and permitted by the context management object 265 and including accessing data in the fixed data storage 290A, 290B as permitted by the context management object 265.

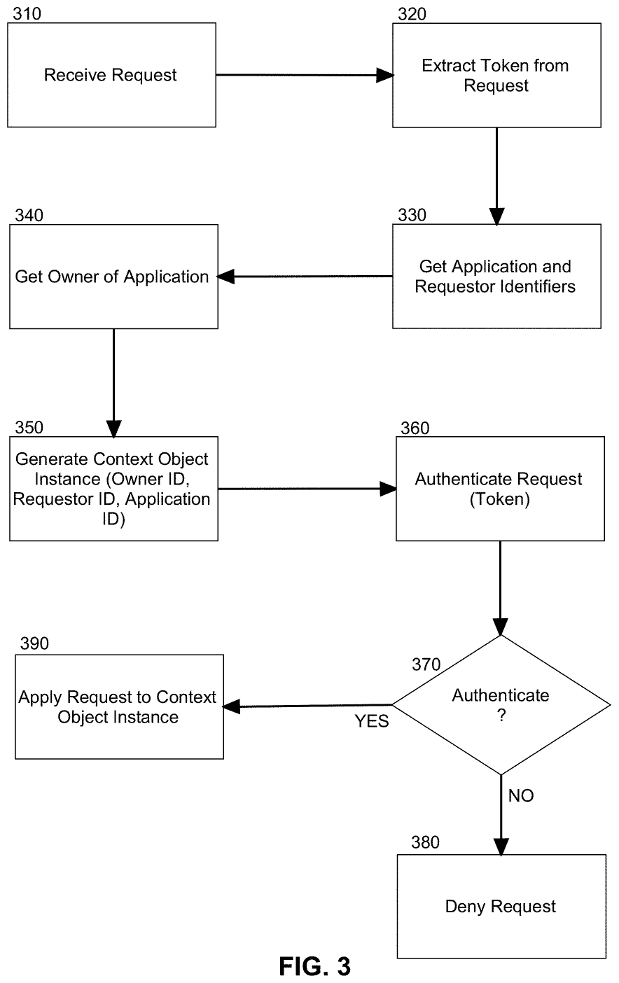

In further illustration of an exemplary operation of the module, FIG. 3 is a flow chart illustrating one of the aspects of the process of FIG. 1. Beginning in block 305, a request is received in the runtime to invoke functionality of or to access data through a specified application instance by an identifiable requestor. A token can be extracted in block 320 from the request which encapsulates therein the identity of the requestor and the targeted application instance. Then, in block 330, the identity of the request and the targeted application instance are retrieved from the token. Thereafter, in block 340, an owner of the targeted application instance is identified.

In block 350, a context management object is created from a previously defined segment of context management code according to the retrieved identities of the requestor, application instance owner and targeted application instance. Thereafter, in block 360, the request is authenticated according to the extracted token. In decision block 370, if the authentication does not permit the request, the request from the requestor is denied in block 380. But, otherwise, in block 390 the request is processed by the created context management object so as to inherently moderate access to the functionality of the targeted application instance, and to the data manipulable through the targeted application instance without requiring the components of the application instance to specifically determine on a case-by-case basis which functions and data can be accessed by a specific requestor in response to a specific request from the requestor.

Of import, the foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or “CPU” of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for deploying multi-enterprise applications in a shared computing environment, the method comprising:
assembling different sets of logical components into different applications for each of the sets and rendering each of the different applications accessible through a common event bus within a single computing container managed by a single runtime process;
assigning to each of the applications, an owner and one or more partners, the owner associated with a deployment and use of a corresponding one of the different applications, each of the partners associated only with the use of the corresponding one of the different applications;
the runtime generating multiple different instances of a context management object from a genetically incorporated segment of a single collection of program code that is arranged to restrict access to one or both of application features and application data according to a tokenized relationship between a requesting entity issuing a request to a corresponding one of the different applications, and an owner of the corresponding one of the different applications; and,
the runtime processing requests from requesting entities, each of the requests targeting one of the different applications, to access the application features and application data of the one of the different applications, by creating one of the instances of the context management object according to a token supplied with each of the requests, the token specifying the requesting entity and a target one of the applications, the genetically incorporated segment moderating the access to the application features and application data irrespective of a particular one of the different applications targeted by each of the requests.

2. The method of claim 1, wherein each one of the requests is received in an event gateway external to the runtime and authenticated before extracting the token from the one of the requests and providing the token with the one of the requests to the runtime.

3. The method of claim 2, wherein the created one of the instances of the context management object invokes a method corresponding to the one of the requests.

4. The method of claim 2, wherein the created one of the instances of the context management object invokes an event handler specified by the one of the requests.

5. A data processing system adapted for deploying multi-enterprise applications in a shared computing environment, the system comprising:
a host computing platform comprising one or more computers, each with memory and one or processing units including one or more processing cores;
a common event bus defined in the memory;
a single computing container executing in the container by the processing cores and hosting different sets of logical components in different applications rendered accessible through the common event bus, each of the applications having assigned thereto an owner and one or more partners, the owner associated with a deployment and use of a corresponding one of the different applications, each of the partners associated only with the use of the corresponding one of the different applications; and,
a runtime comprising computer program instructions enabled while executing in the memory of at least one of the processing units of the host computing platform to perform:
generating multiple different instances of a context management object from a genetically incorporated segment of a single collection of program code that is arranged to restrict access to one or both of application features and application data according to a tokenized relationship between a requesting entity issuing a request to a corresponding one of the different applications, and an owner of the corresponding one of the different applications; and,
processing requests from requesting entities, each of the requests targeting one of the different applications, to access the application features and application data of the one of the different applications, by creating one of the instances of the context management object according to a token supplied with each of the requests, the token specifying the requesting entity and a target one of the applications, the genetically incorporated segment moderating the access to the application features and application data irrespective of a particular one of the different applications targeted by each of the requests.

6. The system of claim 5, wherein each one of the requests is received in an event gateway external to the runtime and authenticated before extracting the token from the one of the requests and providing the token with the one of the requests to the runtime.

7. The system of claim 6, wherein the created one of the instances of the context management object invokes a method corresponding to the one of the requests.

8. The system of claim 6, wherein the created one of the instances of the context management object invokes an event handler specified by the one of the requests.

9. A computing device comprising a non-transitory computer readable storage medium having program instructions stored therein, the instructions being executable by at least one processing core of a processing unit to cause the processing unit to perform a method for deploying multi-enterprise applications in a shared computing environment, the method including:
assembling different sets of logical components into different applications for each of the sets and rendering each of the different applications accessible through a common event bus within a single computing container managed by a single runtime process;
assigning to each of the applications, an owner and one or more partners, the owner associated with a deployment and use of a corresponding one of the different applications, each of the partners associated only with the use of the corresponding one of the different applications;
the runtime generating multiple different instances of a context management object from a genetically incorporated segment of a single collection of program code that is arranged to restrict access to one or both of application features and application data according to a tokenized relationship between a requesting entity issuing a request to a corresponding one of the different applications, and an owner of the corresponding one of the different applications; and,
the runtime processing requests from requesting entities, each of the requests targeting one of the different applications, to access the application features and application data of the one of the different applications, by creating one of the instances of the context management object according to a token supplied with each of the requests, the token specifying the requesting entity and a target one of the applications, the genetically incorporated segment moderating the access to the application features and application data irrespective of a particular one of the different applications targeted by each of the requests.

10. The device of claim 1, wherein each one of the requests is received in an event gateway external to the runtime and authenticated before extracting the token from the one of the requests and providing the token with the one of the requests to the runtime.

11. The device of claim 10, wherein the created one of the instances of the context management object invokes a method corresponding to the one of the requests.

12. The device of claim 10, wherein the created one of the instances of the context management object invokes an event handler specified by the one of the requests.
